(19) United States
(12) Patent Application Publication
(10) Pub. No.: US 2005/0270443 A1
(43) Pub. Date: Dec. 8, 2005

(54) LIQUID CRYSTAL DISPLAY PANEL

(76) Inventors: Chia-Te Lin, Chia-Yi Hsien (TW); Ta-Shuang Kuan, Hsin-Chu Hsien (TW); Ming-Yih Lai, Hsin-Chu Hsien (TW); Kuo-Chou Yu, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 10/709,890

(22) Filed: Jun. 3, 2004

(51) Int. Cl. G02F 1/1335

(52) U.S. Cl. 349/108

(57) ABSTRACT

A liquid crystal display includes a silicon substrate, a micro color filter, a bottom alignment layer, a liquid crystal layer, a top alignment layer, a transparent conductive layer, and a glass substrate stacked in sequence. While a light gets into the liquid crystal display panel, only a specific spectrum of the incident light is transmitted through the micro color filter and is then reflected upward by the silicon substrate to display images.

### BACKGROUND OF INVENTION

1. Field of the Invention

The present invention relates to a liquid crystal display panel, and more particularly, to a liquid crystal on silicon display panel with a micro color filter thereon.

2. Description of the Prior Art

In modern planar display technology, the plasma display panel (PDP) and the liquid crystal display (LCD) are two mainstream products. They both constitute numerous display grids called pixel cells. The former one is applied in a large-sized display market and still does not have widespread application since the technique for mass production has not been perfected yet and the cost is still high. A thin-film transistor LCD (TFT LCD), which has prevailed in recent years, is a representative of the latter one and is mainly applied in the display market smaller than 30 inches. During the fabrication of the TFT LCD products, however, defects such as dots or lines may occur on the LCD. Thus, compensation techniques are required to improve the production yields.

A liquid crystal on silicon (LCOS) display utilizes a silicon chip as a substrate and utilizes a standard CMOS process to form pixel cell matrices, integrated drivers and other electronic devices on the silicon chip. An advantage of the LCOS display is to utilize the CMOS process, since the CMOS process is well developed at the present semiconductor industry. As a result, high stability and reliability can be achieved when compared to the LCD. In addition, using this process, each pixel pitch can be shrunk to less than 10 μm, therefore a high resolution is obtained. When compared to the PDP, the LCOS display not only has an absolute superiority in cost but also has intrinsic advantages of the LCD. In addition, being assisted with adequate projection techniques, the LCOS display can further be applied in markets for large-sized displays. Therefore, the liquid crystal on silicon display attracts many major manufacturers, and is the display with highest potential.

Please refer to FIG. 1, which is a schematic diagram of a conventional liquid crystal display panel 10. As shown in FIG. 1, the liquid crystal display panel 10 includes a silicon substrate 12. A driving circuit 14, a liquid crystal layer 16, a transparent conductive layer 18, a color filter array 22, and a glass substrate 24 are disposed on the surface of the silicon substrate 12 in sequence. The driving circuit 14 includes a plurality of pixel circuits arranged in a matrix. Each of the pixel circuit has a metal electrode to drive the display panel 10 for displaying images. For clarity, only metal electrodes 14a, 14b, and 14c, which are located in a first pixel area 20, a second pixel area 30, and a third pixel area 40 respectively, are illustrated in FIG. 1. The color filter array 22 is formed of a plurality of color filters with different colors, such as a red color filter 22a in the first pixel area 20, a green color filter 22b in the second pixel area 30, and the blue color filter 22c in the third pixel area 40.

Typically, when the liquid crystal display panel 10 attempts to display images, a proper voltage is applied to the driving circuit 14 and the transparent conductive layer 18 and an electric field is formed to control the twisted direction of liquid crystal molecules in the liquid crystal layer 16. Thus, images with different gray levels can be formed by the light transmitting through the liquid crystal layer 16 and reflected by the driving circuit 14 on the surface of the silicon substrate 12. After a gray level light source is made due to the control of the liquid crystal layer 16 and the driving circuit 14, the light passes through color filters coated with red, green, and blue photoresist layers respectively in advance to form red, blue, and green lights. The colorful lights are reflected by the metal electrodes 14a, 14b, and 15c and form a color image in human's eyes.

Since this method is performed by separating the white light into nominal RGB lights and combining the RGB lights again to form a color image, this color separation and combination lead to some disadvantages, such as complicated mechanism, large volume, high manufacture costs, and low reliability. In addition, according to the position of the liquid crystal layer 16, the processes of fabricating the liquid crystal display panel 10 are typically divided into two parts, which are processes on the silicon substrate 12 and processes on the glass substrate 24. After both substrates and elements thereon are made, a combining process is carried out to combine the silicon substrate 12 and the glass substrate 24. Afterward, liquid crystal molecules are filled into the space between the two substrates to form the liquid crystal layer 16. However, since the color filter 22 is formed on the glass substrate 24 and the location of each pixel area is defined in the silicon substrate 12, an additional alignment process is needed while combining the glass substrate 24 and the silicon substrate 12. If the color filter 22a, 22b, and 22c can not be precisely aligned with the metal electrodes 14a, 14b, 14c, it makes three color lights become unequal and the display performance is deteriorated thereby. Moreover, when the color filter array 22 transfers the white light to a specific color light, such as red, green, or blue, some energy is absorbed so that accumulation heat is generated, leading to an increased temperature after operating for a period of time, and the display performance is also affected.

Thus, a new liquid crystal display panel is strongly required to solve the aforementioned problems.

### SUMMARY OF INVENTION

It is therefore a primary objective of the claimed invention to provide a liquid crystal display panel that comprises a micro color filter array located on the silicon substrate to solve the aforementioned problems in the prior art.

In a preferred embodiment of the claimed invention, a liquid crystal on silicon (LCOS) display panel is disclosed. The LCOS display panel includes a silicon substrate. A first micro color filter, a second micro color filter, and a third micro color filter are located in a first pixel area, a second pixel area, and a third pixel area on the silicon substrate respectively. Additionally, a bottom alignment layer, a liquid crystal layer, a top alignment layer, a transparent conductive layer, and a glass substrate are stacked on the first micro color filter, the second micro color filter, and the third micro color filter in sequence. The first micro color filter, the second micro color filter, and the third micro color filter are all formed of a plurality of stacked optical thin films. When light enters the display panel, lights of a first specific spectrum, a second specific spectrum, and a third specific spectrum are reflected from the first pixel area, the second pixel area, and the third pixel area respectively.

It is an advantage of the claimed invention that micro color filters are used to form color images so that the fabricating process can be simplified and the product volume can be reduced. In addition, since the micro color filter is located under the liquid crystal layer adjacent to the silicon substrate, the alignment precision between the micro color filter and the pixel area on the silicon substrate can be further improved, leading to enhancing the display performance of the LCOS display panel.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a schematic diagram of a conventional display panel in the prior art.

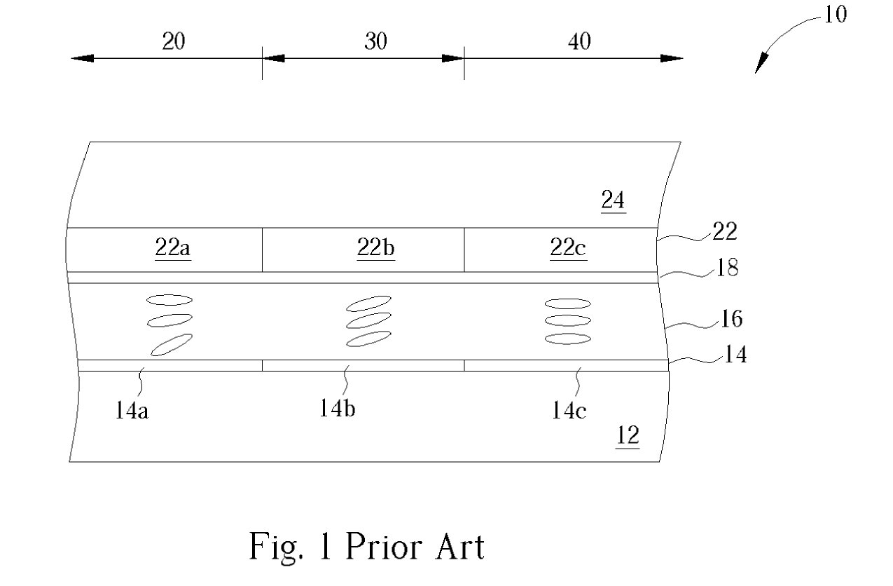

FIG. 2 is a schematic diagram of a display panel according to a first embodiment of the present invention.

FIG. 3 is a schematic diagram of a display panel according to a second embodiment of the present invention.

### DETAILED DESCRIPTION

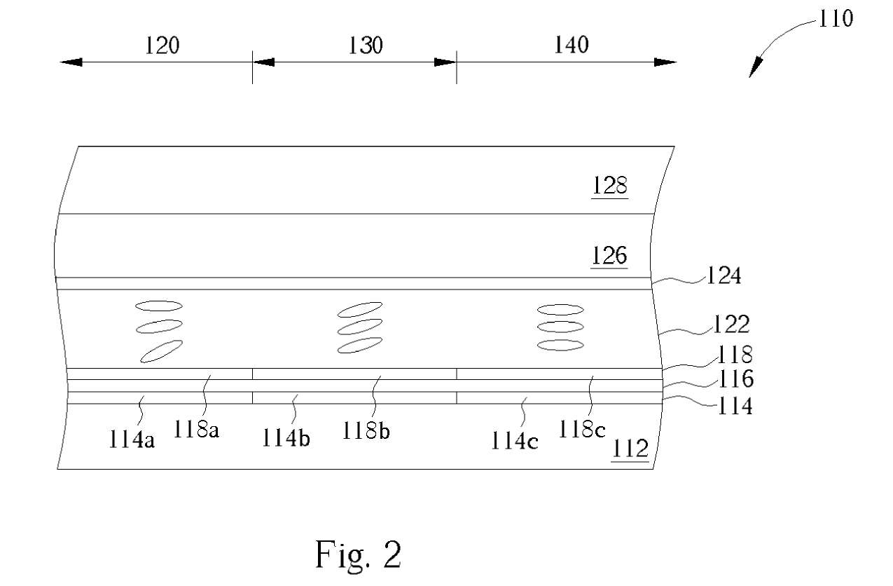

Please refer to FIG. 2, which is a schematic diagram of a display panel 110 according to a first embodiment of the present invention. As shown in FIG. 2, the liquid crystal display panel 110 includes a silicon substrate 112. A driving circuit 114, a bottom alignment layer 116, a micro color array 118, a liquid crystal layer 122, a top alignment layer 124, a transparent conductive layer 126, and a glass substrate 128 are disposed on the surface of the silicon substrate 112 in sequence. The driving circuit 114 includes a plurality of pixel circuits arranged in a matrix. Each of the pixel circuits has a metal electrode to drive the display panel 110 for displaying images. For clarity, only metal electrodes 114a, 114b, and 114c, which are located in a first pixel area 120, a second pixel area 130, and a third pixel area 140 respectively, are illustrated in FIG. 2. The micro color filter array 118 is formed of a plurality of color filters with different colors, such as a red micro color filter 118a in the first pixel area 120, a green micro color filter 118b in the second pixel area 130, and the blue micro color filter 118c in the third pixel area 140. The micro color filters 118a, 118b, and 118c only permit lights of a first specific spectrum, a second specific spectrum, and a third specific spectrum to pass respectively. In a preferred embodiment of the present invention, the lights of the first specific spectrum, the second specific spectrum, and the third specific spectrum are red, green, and blue lights respectively. In addition, a location of each micro color filter of the micro color filter array 118 corresponds to the metal electrodes 114a, 114b, and 114c respectively so that the lights passing through the micro color filters 118a, 118b, and 118c are reflected upward by the metal electrodes 114a, 114b, and 114c respectively. As a result, lights with different specific spectrums are mixed and combined again to form a color image.

In a preferred embodiment of the present invention, the liquid crystal layer 122 has a thickness of 0.5 to 10 microns and further includes a top alignment layer 124 and a bottom alignment layer in a top side and a bottom side of the liquid crystal layer 122 respectively to make the liquid crystal molecules in the liquid crystal layer have a predetermined tilt angle while no electric field applied thereon. In a preferred embodiment of the present invention, the liquid crystal layer 122 comprises liquid molecules aligned in a homeotropic type. However, the liquid crystal molecules of the present invention is not limited to be aligned in the homeotropic type, but can be aligned in other types, such as a twist nematic type.

The first micro color filter 118a, second micro color filter 118b, and third micro color filter 118c are formed of a plurality of stacked optical thin films. Typically, the first micro color filter 118a, second micro color filter 118b, and third micro color filter 118c include a low index optical stack, which is formed of a silicon oxide layer, or a high index optical thin film stack, which is formed of a titanium oxide (TiO₂) layer or a tantalum oxide (Ta₂O₅) layer. Normally, the micro color filter array 118 has a thickness of 1 to 5 microns. In addition, an opaque layer is coated among each micro color filter to reduce interferences between different color lights and improve the signal to noise ratio, leading to an enhanced display performance. The materials of the opaque layer can be selected from any one of Al, Cr, Ni, Cu, Fe, Zn, Ti, Au, Ag, Pt, W, Mo, Ta, Zr, C or mixtures of them.

Since the micro color filter array 118 is located under the liquid crystal layer 122, the micro color filter array 118 and the driving circuit 114 is fabricated in the side of the silicon substrate 112 during the fabricating process of the liquid crystal display panel 110. As a result, the additional alignment process between the glass substrate 128 and the silicon substrate 112 can be omitted since the alignment requirement between the glass substrate 128 and the silicon substrate 112 is lowered, improving the display performance thereby. In addition, since the color micro filter array 118 is disposed on the silicon substrate 112, a cooling system can be added into a peripheral region of the silicon substrate 112 to remove the accumulation heat generated from the micro color filter array 118 to reduce the increase in temperature.

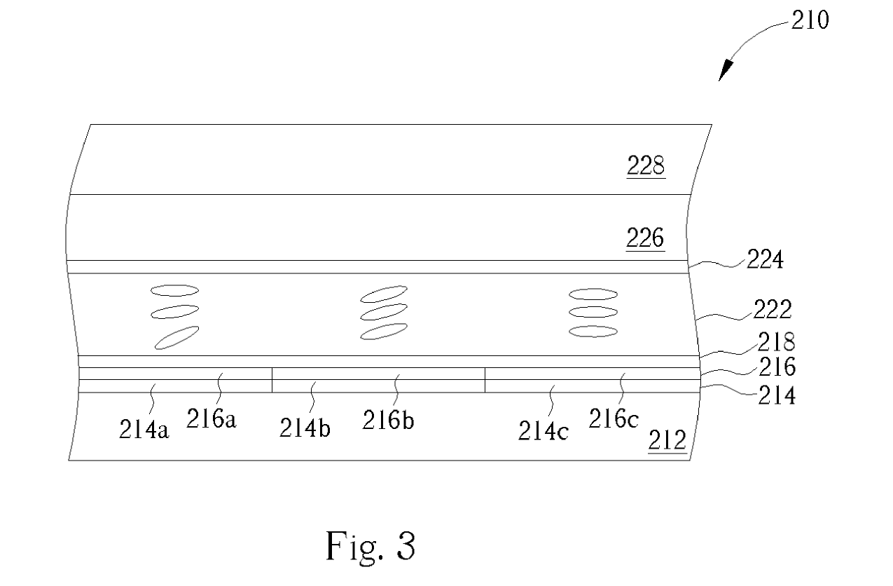

Please refer to FIG. 3, which is a schematic diagram of a display panel 210 according to a second embodiment of the present invention. As shown in FIG. 3, a display panel 210 is similar to the display panel 110 mentioned in the first embodiment of the present invention. The display panel 210 includes a silicon substrate 212. A driving circuit 214, a micro color array 216, a bottom alignment layer 218, a liquid crystal layer 222, a top alignment layer 224, a transparent conductive layer 226, and a glass substrate 228 are disposed on the surface of the silicon substrate 212 in sequence. The micro color filter 216 similarly includes a first micro color filter 216a, a second micro color filter 216b, and a micro color filter 216c located on metal electrodes 214a, 214b, and 214c respectively. The significant difference between the present embodiment and the first embodiment is that each micro color filter is located under the bottom alignment layer 218. In another words, the micro color filter is formed on the metal electrode directly. It has an advantage of improving the reflective index by utilizing the interface between the micro color filter and the metal electrode below. Normally, the metal electrode has a reflective index of about 90%, but the interface between the micro color filter and the metal electrode has a reflective index of about 97%. As a result, the brightness of the display panel can be enhanced and the display performance is improved thereby.

In contrast to the prior art, the present invention utilizes a micro color filter array to form color images so that the fabricating process can be simplified and the product volume can be reduced in advance. In addition, since the micro color filter array is located under the liquid crystal layer, the micro color filter array and the driving circuit are both formed on the silicon substrate during the fabricating process. Thus, the alignment requirement between the silicon substrate and the glass substrate is reduced significantly, leading to an improvement of product reliability. Moreover, since the micro color filter array is located in the side of the silicon substrate, a cooling system can be added in the peripheral region of the silicon substrate to remove the accumulation heat and reduce the increase in temperature.

Those skilled in the art will readily observe that numerous modifications and alterations of the device may be made while retaining the teaching of the invention. Accordingly, the above disclosure should be construed as limited only by the metes and bounds of the appended claims.

1. A display panel comprising:
a silicon substrate with a pixel area located in a surface of the silicon substrate;
a micro color filter disposed on the pixel area on the silicon substrate;
a liquid crystal layer disposed on the micro color filter;
a top alignment layer positioned on the liquid crystal layer; and
a transparent conductive layer disposed on the top alignment layer;
wherein when light enters into the display panel, only a specific spectrum of light is permitted to transmit through the micro color filter and is then reflected up-ward by the silicon substrate to form images.

2. The display panel of claim 1 wherein the display panel further comprises a bottom alignment layer disposed between the liquid crystal layer and the micro color filter.

3. The display panel of claim 1 wherein the display panel further comprises a bottom alignment layer disposed between the silicon substrate and the micro color filter.

4. The display panel of claim 1 wherein the display panel further comprises a driving circuit disposed on the surface of the silicon substrate, the driving circuit comprising a plurality of metal electrodes to reflect incident light through the micro color filter upward to form images.

5. The display panel of claim 1 wherein the micro color filter is composed of a plurality of stacked optical thin films, and comprises a low index optical thin film stack or a high index optical thin film stack.

6. The display panel of claim 5 wherein the low index optical thin film stack comprises a silicon oxide (SiO₂) layer.

7. The display panel of claim 5 wherein the high index optical thin film comprises a titanium oxide (TiO₂) layer or a tantalum oxide (Ta₂O₅) layer.

8. The display panel of claim 1 wherein the liquid crystal layer comprises liquid molecules aligned in a homeotropic type or a twist nematic type.

9. The display panel of claim 1 wherein a thickness of the liquid crystal layer is about 0.5 to 10 microns.

10. A display panel comprising:
a silicon substrate with a first pixel area, a second pixel area, and a third pixel area defined in a surface of the silicon substrate;
a first micro color filter, a second micro color filter, and a third micro color filter respectively disposed in the first pixel area, the second pixel area, and the third pixel area on the surface of the silicon substrate;
a bottom alignment layer disposed on the first micro color filter, the second micro color filter, and the third micro color filter;
a liquid crystal layer disposed on the bottom alignment layer;
a top alignment layer disposed on the liquid crystal layer; and
a transparent conductive layer disposed on the top alignment layer;
wherein when light enters the display panel, lights of a first specific spectrum, a second specific spectrum, and a third specific spectrum are reflected from the first pixel area, the second pixel area, and the third pixel area respectively.

11. The display panel of claim 10 wherein the display panel further comprises a driving circuit disposed on a surface of the silicon substrate to drive the substrate and reflect light transmitting through the first micro color filter, the second micro color filter, and the third micro color filter upward to form images.

12. The display panel of claim 10 wherein light of the first specific spectrum, the second specific spectrum, and the third specific spectrum are red, blue, and green light respectively.

13. The display panel of claim 10 wherein each of the first micro color filter, the second micro color filter, and the third micro color filter is composed of a plurality of stacked optical thin films, and comprises a low index optical thin film stack or a high index optical thin film stack.

14. The display panel of claim 13 wherein the low index optical thin film stack comprises a silicon oxide (SiO₂) layer.

15. The display panel of claim 13 wherein the high index optical thin film comprises a titanium oxide (TiO₂) layer or a tantalum oxide (Ta₂O₅) layer.

16. The display panel of claim 10 wherein the liquid crystal layer comprises liquid molecules aligned in a homeotropic type or a twist nematic type.

17. The display panel of claim 10 wherein a thickness of the liquid crystal layer is about 0.5 to 10 microns.

18. The display panel of claim 10 wherein the display panel further comprises a cooling system on the silicon substrate.
